(19) United States
(12) Patent Application Publication
(10) Pub. No.: US 2015/0372568 A1
(43) Pub. Date: Dec. 24, 2015

(54) ELECTRICAL MACHINE WITH DIRECT STATOR COOLING

(71) Applicant: SIEMENS AKTIENGESELLSCHAFT, München (DE)

(72) Inventor: OLAF KÖRNER, Nürnberg (DE)

(73) Assignee: Siemens Aktiengesellschaft, 80333 München (DE)

(21) Appl. No.: 14/765,500

(22) PCT Filed: Jan. 17, 2014
(86) PCT No.: PCT/EP2014/050893

§ 371 Date: Aug. 3, 2015

(30) Foreign Application Priority Data
Feb. 4, 2013 (DE) 10 2013 201 778.2

(51) Int. Cl. H02K 9/19; H02K 1/32

(52) U.S. Cl. CPC H02K 9/19; H02K 1/32

(57) ABSTRACT

An electromechanical transducer includes at least one rotor which is arranged on a shaft and is arranged in an encapsulated stator. The stator has a laminated core and a winding which are surrounded by an insulating cooling fluid. The cooling fluid can be introduced via first cooling ducts which are arranged radially with respect to the shaft in the center of the stator and can be discharged at each axial end of the stator radially with respect to the shaft via second cooling ducts in the winding head region, or vice versa. As a result it is possible to provide a compact and robust electromechanical transformer which owing to its lightweight design with a high torque density is suitable for use, for example, in aircraft or other vehicles.

The invention relates to an electromechanical transducer with direct stator cooling.

Electromechanical transducers have already been known for a relatively long time. As fossil fuels which are used to drive different vehicles have become scarce, electromechanical transducers have also been used to a great extent in this field. On account of their robustness, their simple design and high degree of efficiency, electromechanical transducers are nowadays also installed in vehicles—hybrid vehicles—or aircraft. Depending on requirements, the electromechanical transducers are used as generators or motors. Said electromechanical transducers are used both as a vehicle drive and also as a generator—for recovering electrical energy, for example during braking of a vehicle -primarily in vehicles with an electric drive or else partially electric drive—hybrid vehicles.

In order to minimize the consumption of energy by the vehicles, efforts are made to design electromechanical transducers which have as high a degree of efficiency as possible. To this end, the power losses during operation of the electromechanical transducer have to be minimized. In the case of electromechanical transducers which are subject to high utilization, for example in the case of a permanent-magnet machine with toothed coil winding, high current densities are required in order to achieve high torque and power densities. In this case, copper losses occur owing to the armature current coverage for the torque-forming current, eddy current losses and hysteresis losses in laminated iron cores of the electromechanical transducer and also additional losses on account of friction, flow losses in the motor etc. In particular, the copper losses increase quadraticatically with the adopted torque. In this case, these losses lead to a high degree of heating of the electromechanical transducer, this in turn possibly causing relatively high losses and furthermore leading to destruction of the electromechanical transducer.

In order to minimize the power losses of the electromechanical transducer, different cooling concepts are pursued nowadays. Air cooling systems are used in small electromechanical transducers, whereas cooling operations are performed using a cooling fluid in the case of large electromechanical transducers.

In the case of electromechanical transducers which are subject to high utilization, high power losses occur, these leading to a high level of heating of the electromechanical transducer. Cooling systems with cooling fluids are required in order to be able to dissipate the temperatures which occur. In order to allow intensive direct cooling of a stator of an electromechanical transducer which is subject to high utilization, a coolant is, for example, supplied at one end of a winding head region of the electromechanical transducer and discharged at another end of the winding head region of the electromechanical transducer. The heated cooling fluid is then cooled again and supplied to the electromechanical transducer once again. One example of a cooling apparatus of this kind is found, for example, in a known “Williams Hybrid Power” flywheel accumulator.

The object of the present invention is to provide an electromechanical transducer with a cooling arrangement which allows uniform cooling given a compact design of the electromechanical transducer, and an increase in the degree of efficiency and in the power and torque densities.

This object is achieved by an electromechanical transducer having at least one rotor which is arranged on a shaft and is arranged in an encapsulated stator, the laminated core and winding of said stator being surrounded by an insulating cooling fluid, wherein the cooling fluid can be introduced via first cooling ducts which are arranged radially in relation to the shaft in the center of the stator, and can be discharged radially to the shaft at each axial end of the stator via second cooling ducts in the winding head region, or vice versa. A construction of this kind allows direct and intensive cooling of the electromechanical transducer. The power loss is minimized by the cooling at the same time.

In a preferred embodiment of the invention, the electromechanical transducer is mounted in a carrying structure, wherein a wall of at least one of the first cooling ducts, which are arranged in the center of the stator, is used to form a bearing for the electromechanical transducer on the surrounding carrying structure. As a result, installation space is saved and, at the same time, possible vibrations are prevented due to a stable structure of the electromechanical transducer.

In a particularly advantageous embodiment of the invention, the rotor on the shaft is of split design. As a result, it is particularly easy for cooling air to be radially delivered to the center of the rotor, said cooling air then flowing through an air gap in the machine axially in both directions. In addition, uniform cooling of the rotor is possible. Furthermore, owing to the split in the rotor, installation space which becomes free can optionally additionally be used for arranging a bearing—preferably a floating bearing—in a space- and weight-saving manner.

In a further expedient embodiment of the invention, a wall of at least one of the first cooling ducts, which are arranged in the center of the stator, is used to form a bearing for the shaft of the rotor on the stator. In this way, it is possible to additionally support the rotor against the stator. This allows a stable design of the electromechanical transducer.

In order to keep the weight of the electromechanical transducer as low as possible, the radial first and/or second cooling ducts are produced from fiber composite materials. Fiber composite materials are particularly lightweight and at the same time very durable.

The first and second cooling ducts are preferably produced from magnetically impermeable and/or electrically non-conductive materials. Materials of this kind minimize the power loss which is caused by electromagnetic influences.

In order to be able to effectively cool the rotor of the electromechanical transducer, the rotor has cooling ducts which run parallel and/or radial to the shaft. Air for cooling purposes can be routed through these cooling ducts.

It is particularly expedient to design electromechanical transducers of this kind for a maximum power of up to 1 MW. As a result, the dimensions can be kept small, and respectively the installation space in a vehicle or an aircraft can be utilized in an optimum manner.

In order to save installation space, the shaft of the electromechanical transducer is in the form of a drive shaft which is connected to an internal combustion engine in an expedient embodiment.

The invention and exemplary embodiments will be explained in greater detail below with reference to a drawing, in which:

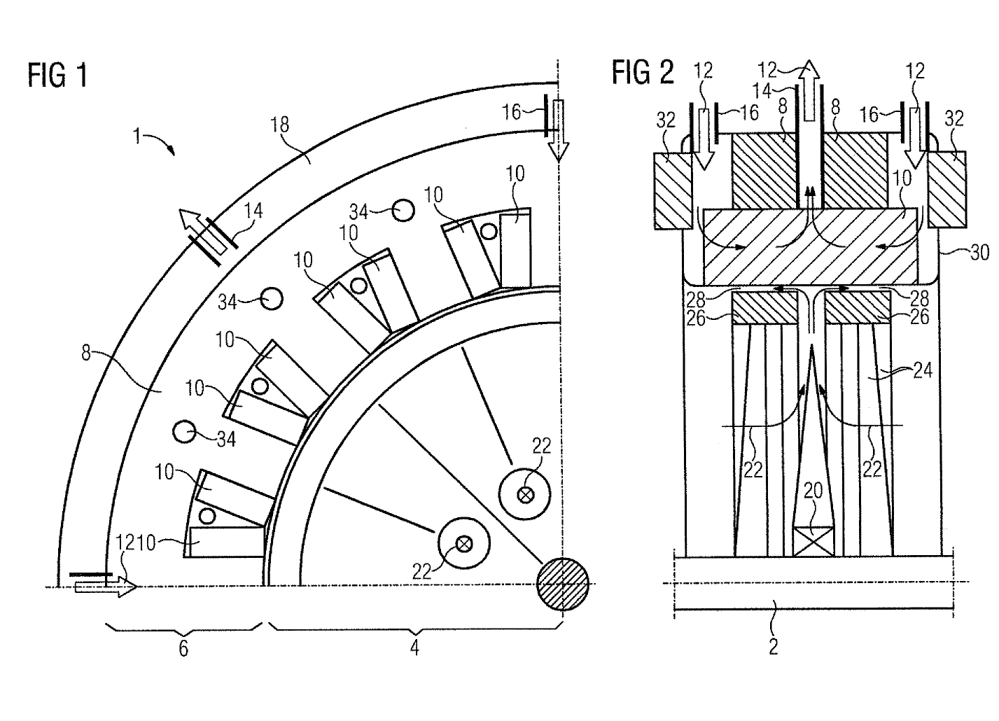

FIG. 1 shows a quarter of a sector of a circle of a Longitudinal section through an electromechanical transducer according to one embodiment of the invention; and

FIG. 2 shows half of a cross section through an electromechanical transducer according to one embodiment of the invention.

FIG. 1 shows a quarter of a longitudinal section through the rotationally symmetrical electromechanical transducer 1 parallel through its shaft 2. FIG. 2 shows half of the cross section through the rotationally symmetrical electromechanical transducer 1 perpendicular to a shaft 2. In this case, the wide arrows in FIG. 1: and FIG. 2 represent a course of an insulating cooling fluid 12 through a stator 6 and narrow arrows show a possible course of a cooling gas, generally air, through a rotor 4 of the electromechanical transducer 1. Identical reference symbols are used to denote identical elements in the respective figures.

FIG. 1 shows a stator 6 which is mounted in a carrying structure 18 of the electromechanical transducer 1—for example a housing of the electromechanical transducer 1. In FIG. 1, the carrying structure 18 is indicated merely as a concentric outer circle. Owing to the high electrical power losses which occur in the stator 6, the stator 6 is heated to a considerable extent. A contribution is made to said heating substantially by hysteresis losses and eddy current losses in the laminated cores 8 and also resistance losses through windings 10. Since the temperatures which occur as a result can increase to a great extent in such a way that the insulation and therefore the entire stator 6 can be destroyed, cooling of the stator is essential. Furthermore, cooling also automatically reduces the power loss of the electromechanical transducer 1.

A particularly advantageous arrangement and guidance of a cooling fluid 12—wide arrows—is shown in the illustrated embodiment. The cooling fluid 12 is expediently an insulating liquid. This not only allows direct and intensive cooling of the stator 6 but a high degree of reliability of a winding insulation against faults is also achieved—not shown here. A particular advantage is that a winding short can be avoided in permanent-magnet machines. Furthermore, a main insulation can be reduced or completely dispensed with; apart from at points where conductor elements of the winding 10 make contact with an electrically conductive laminated core 8.

The insulating cooling fluid 12 is preferably introduced radially in relation to the shaft 2 at each axial end of the stator 6 on both sides of the winding head region, wherein said cooling fluid flows through the winding 10 or is guided along the winding 10 and cools said winding, in order to then be discharged again in a center of the stator through a radial, circumferential cooling duct 14. In a further embodiment of the invention, the flow direction takes place in the opposite direction. The particular advantage of an arrangement of this kind is that an active part 26 of the stator 6—the winding 10—is cooled more uniformly than in comparison to conventional cooling fluid guides—which are routed from a winding head region at one axial end of the stator 6 to the other winding head region at the opposite axial end of the stator 6.

In order to prevent the insulating cooling fluid 12 of the stator 6 from coming into contact with the rotor arranged in said stator, said rotor has to be encapsulated 30.

In order to further optimize the cooling effect of the electromechanical transducer, cooling ducts 34 for air can be provided within the stator 6, said cooling ducts running parallel to the shaft 2, in a further advantageous embodiment.

Taking into account the reference signs from FIG. 1, FIG. 2 shows a rotor 4 which has a shaft 2 on which an active part 26 of the rotor 4 is arranged by means of ribs 24. The rotor 4 is split into two, so that cooling air can be delivered to the center of the rotor radially to the shaft 2, said cooling air being supplied to the rotor 4 via cooling ducts 22 which run parallel to the shaft 2. The air can then escape axially in both directions through an air gap 28 in the electromechanical transducer 1 between the rotor 4 and the stator 6. Sufficient cooling for the rotor 4 is achieved as a result. In order to improve the cooling power of the rotor 4, the ribs 24 of the rotor 4 are configured in such a way that they have a radial fan effect.

In the embodiment shown in FIG. 2, a power electronics system 32 of the electromechanical transducer 1 can also optionally be cooled by the insulating cooling fluid 12 also being routed past the power electronics system 32 or washing around the power electronics system 32—which is located in an additional housing—itself.

In a further advantageous embodiment, a wall of the radial central cooling duct 14 can also be designed to form the bearing 20 of the shaft 2 of the rotor 6, and as a result can be used to support the shaft 2 of the rotor 4 against the stator 6. As a result, the electromechanical transducer 1 can be of stable construction and is able to absorb high torques.

Firstly, splitting the rotor can clear installation space, it being possible for this installation space to be optionally used to arrange the above-mentioned bearing 20 in a space- and weight-saving manner.

In this way, a suspension/torque support means is combined with radial cooling duct 14.

The embodiment of the electromechanical transducer 1 shown in FIG. 1 and FIG. 2 can also be fitted directly to an internal combustion engine as a bearing-free generator. For example, a stator housing—supporting structure 18—can be fastened directly to a flywheel housing of the internal combustion engine. In this case, the rotor 4 is mounted directly on a flywheel/a crankshaft of the internal combustion engine—not shown here.

Electromechanical transducers of this kind are particularly suitable for vehicles or aircraft when they are designed for a maximum power of up to 1 MW. As a result, it is possible to provide a compact and robust electromechanical transducer 1 which, on account of its lightweight design with a high torque density, is suitable for use, for example, in aircraft or other vehicles in which lightweight, compact and therefore powerful machines are required. The intensive and direct cooling by means of the insulating cooling fluid 12 furthermore ensures an increased degree of efficiency.

1.-9. (canceled)

10. An electromechanical transducer, comprising:
a shaft;
an encapsulated stator having a laminated core and a winding;
at least one rotor arranged on the shaft and arranged in the stator; and
a cooling system for cooling the stator by cooling fluid flowing around the laminated core and the winding, said cooling system having first cooling ducts, arranged radially in relation to the shaft in a center of the stator, for introduction of the cooling fluid, and second cooling ducts, arranged in the winding head region at each axial end of the stator, for discharge of the cooling fluid in radial relationship to the shaft, or vice versa, at least one of the first cooling ducts having a wall configured to form a bearing for the shaft on the stator.

11. The electromechanical transducer of claim 10, further comprising a carrying structure for support of the electromechanical transducer, at least one of the first cooling ducts having a wall to form a bearing for the electromechanical transducer on the surrounding carrying structure.

12. The electromechanical transducer of claim 10, wherein the rotor has a split configuration.

13. The electromechanical transducer of claim 10, wherein the first and/or second cooling ducts are produced from fiber composite material.

14. The electromechanical transducer of claim 10, wherein the first and second cooling ducts are produced from magnetically impermeable and/or electrically non-conductive material.

15. The electromechanical transducer of claim 10, wherein the rotor has cooling ducts extending in parallel and/or radial relation to the shaft.

16. The electromechanical transducer of claim 10, constructed for a maximum power of up to 1 MW.

17. The electromechanical transducer of claim 10, wherein the shaft is a drive shaft which is connected to an internal combustion engine.
